(19) United States
(12) Patent Application Publication
(10) Pub. No.: US 2003/0219333 A1
(43) Pub. Date: Nov. 27, 2003

(54) Semiconductor support mechanism for sample stage

(76) Inventor: Toshitada Takeuchi, Chiba-shi (JP)

Correspondence Address: ADAMS & WILKS, 31st Floor, 50 Broadway, New York, NY, 10004, US

(21) Appl. No.: 10/410,227

(22) Filed: Apr. 9, 2003

(30) Foreign Application Priority Data
Apr. 10, 2002 (JP) 2002-108309

(51) Int. Cl. B66C 23/00

(52) U.S. Cl. 414/744.6

(57) ABSTRACT

The object of the present invention is to provide a wafer support mechanism for a sample stage that does not require a special drive source for attaching and detaching a wafer to be provided within a sample chamber so as to eliminate problems with lining up drive portions occurring as a result of the drive source being provided outside so as to provide a stable and reliable mechanism that is not restricted by problems regarding environment. The semiconductor wafer support mechanism of the present invention is provided with at least three arms with pawls capable of sliding in a radial direction on a sample stage so as to hold and release a wafer and comprises means for urging the arms for holding the wafer inwards in a radial direction and means for broadening the arms urged towards the inside towards the outside when the slider is in a state of close proximity with the sample stage in unison with an operation of conveying the semiconductor wafer performed by a slider between a pre-chamber and a sample stage of a sample chamber.

### BACKGROUND OF THE INVENTION

1. Field of The Invention

The present invention relates to a mechanism for supporting a semiconductor wafer constituting an object to be tested on a sample stage of a sample chamber when monitoring a semiconductor wafer using an electron microscope or ion microscope or processing a semiconductor wafer using a focused ion beam.

2. Description of Related Art

Mechanisms (devices) are necessary for supporting wafers in a reliable and stable manner on a sample stage in a sample chamber (chamber) within which a vacuum is maintained, in order to monitor the surface of a semiconductor wafer using an electron microscope or ion microscope or in order to process the surface of a semiconductor wafer using a focused ion beam device. Normally, a wafer is mounted on a stage provided at the uppermost part of a multi-axial drive mechanism consisting of an XYZ three-dimensional drive mechanism, a tilting mechanism, and a rotating mechanism, etc. A sample stage 1 shown schematically in FIG. 6 is provided within a sample chamber 2 and with a wafer 10 mounted on the sample stage 1 being withdrawn and introduced via a pre-chamber 3. In a procedure where a wafer 10 constituting a sample is conveyed from the atmosphere into the sample chamber 2, first, a door V1 of the pre-chamber 3 is opened in a situation where a shielding bridge wall V2 between the sample chamber 2 held at a vacuum and the pre-chamber 3 is in a closed state. The wafer 10 constituting the sample 10 is mounted on a slider 5 located within the pre-chamber 3 and a door V1 of the pre-chamber 3 is closed. Next, air in the pre-chamber 3 is exhausted, and pre-chamber 3 is in a vacuous state that is the same as that of the sample chamber 2. A shielding bridge wall V2 between the sample chamber 2 and the pre-chamber 3 is then opened. During this time, a position is decided so that the sample stage 1 within the sample chamber 2 stands face to face with the pre-chamber 3. The slider 5 causes the wafer 10 to pass through the shielding bridge wall V2 using a slider mechanism (not shown) and conveys the wafer 10 to on top of the sample stage 1. The slider 5 then displaces itself downwards, deposits the wafer 10 onto the sample stage 1, retracts, and returns to a prescribed position that is the original position of the pre-chamber 3. When the wafer 10 is deposited on the sample stage 1 within the sample chamber 2, the shielding bridge wall V2 is closed and the shield of the sample chamber 2 is ensured. The sample stage 1 is then moved to lower desired position of the lens barrel (not shown) by a drive mechanism and monitoring or processing is implemented. When the operation is complete the sample stage 1 on which the wafer 10 is mounted is moved to a position confronting the pre-chamber 3 by this drive mechanism and the shielding bridge wall V2 for the pre-chamber 3 for which the door V1 is closed is opened. The slider 5 is then advanced forwards to a position below the wafer 10 of the sample stage 1 by the slide mechanism (not shown). The slider 5 itself is then moved upwards from this position, pulls the wafer 10 away from the sample stage 1, retracts, and returns to a prescribed position of the pre-chamber 3 through the shielding bridge wall V2. The shielding bridge wall V2 is closed and the door V1 of the pre-chamber 3 is opened with the shield of the sample chamber assured, and the wafer 10 is returned back to the atmosphere.

The wafer constituting the sample is typically disc-shaped and holding occurring at the sample stage 1 where a tightly-held state is attained by pressing from the outer side centripetally is adopted. A drive device such as a motor or air cylinder is therefore required because this holding device is driven mechanically. It is therefore necessary to provide various equipment such as secondary electron detectors, X-ray detectors or gas guns in the chamber in addition to a charge particle optical system and stage drive mechanism, and the arrangement of the drive mechanism for supporting the wafer is therefore painful from a design point of view. Further, a problem with providing the chamber in a location that is held in a vacuum state is that this may adversely affect the air cylinder, and this presents the problem that usage is limited to types employing ultrasonic motors rather than types employing electromagnetic motors generating electromagnetic waves. It is therefore difficult to position driving members when driving from outside (the atmosphere side) of the chamber.

It is therefore the object of the present invention to provide a wafer support mechanism for a sample stage that does not require a special drive source for attaching and detaching a wafer to be provided within a sample chamber so as to eliminate problems with lining up drive portions occurring as a result of the drive source being provided outside so as to provide a stable and reliable mechanism that is not restricted by problems regarding environment.

### SUMMARY OF THE INVENTION

The semiconductor wafer support mechanism of the present invention is provided with at least three arms with pawls capable of sliding in a radial direction on a sample stage so as to hold and release a wafer and comprises means for urging the arms for holding the wafer inwards in a radial direction and means for broadening the arms urged towards the inside towards the outside when the slider is in a state of close proximity with the sample stage in unison with an operation of conveying the semiconductor wafer performed by a slider between a pre-chamber and a sample stage of a sample chamber. The urging means and means for broadening the urged arms to the outside may comprise contacting means fitted to the sliders, a rotating lever provided at the sample stage so as to make contact with the contacting member, a spring urging the rotating lever in one direction and a cam mechanism for causing rotation of the rotating lever to cause the arms with pawls to slide in a radial direction, or alternatively may comprise a rack member fitted to the slider, a gear provided at the sample stage meshing with the rack member, a gear train for transmitting rotation of the gear, a mechanism for causing the arms with pawls to slide in the radial direction using the rotation force of the gear train, and a spring for urging the gears of the gear train in one direction of rotation.

### BRIEF DESCRIPTION OF THE DRAWINGS

FIG. 1 is a view illustrating the structure of the main parts of the slider of the present invention and movement during conveying in and conveying out.

FIG. 2 is a view showing a first embodiment of the present invention, with FIG. 2A being a plan view and FIG. 2B being a solid view.

FIG. 3 is a view illustrating the interlocking operation of the lever members receiving the motion of the slider and the cam mechanism of the first embodiment.

FIG. 4 is a view showing a second embodiment of the present invention, with FIG. 4A being a plan view and FIG. 4B being a solid view.

FIG. 5 is a view illustrating the interlocking operation of a rack member receiving the motion of the slider and the gear mechanism of the second embodiment.

FIG. 6 is a view illustrating the environment for conveying a sample in an out of an electron microscope, an ion microscope or a focused ion beam device.

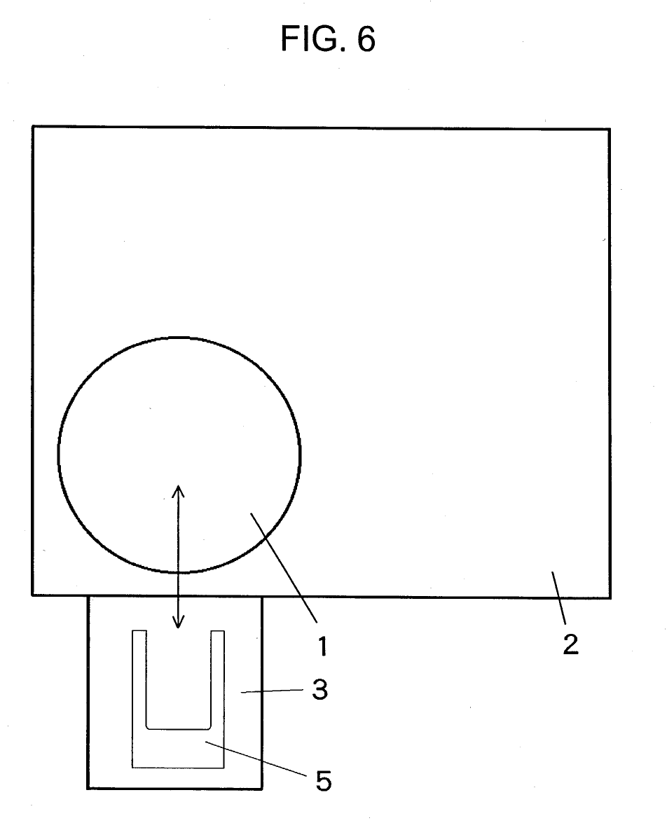

### DETAILED DESCRIPTION OF THE INVENTION

The present invention is therefore a wafer support mechanism for a sample stage for when the surface of a semiconductor wafer is monitored using an electron microscope or ion microscope or is processed using a focused ion beam device and deals with the situation where arrangement of a drive mechanism for supporting the wafer is difficult from a design point of view due to various types of equipment having to be located in the chamber in addition to the charged particle optical system and stage drive mechanism. Further, a problem with providing the chamber in a location that is held in a vacuum state is that this may adversely affect the air cylinder, and this presents the problem that usage is limited to types employing ultrasonic motors rather than types employing electromagnetic motors generating electromagnetic waves. It is therefore difficult to position driving members when driving from outside of the chamber. Providing of the drive mechanism for supporting the wafer separately is therefore stopped and it is considered to interlock the operation of depositing and withdrawing using means for conveying the wafer between the pre-chamber and sample stage within the sample chamber provided in the related art, i.e. to provide a mechanism for supporting and releasing the wafer on the sample stage using this drive source. In order to resolve the aforementioned problems by using this kind of configuration, there is provided a reliable and stable wafer support mechanism that does not necessitate the provision of a special drive source within the sample chamber, where there is no problem lining up drive portions due to such drive portions being provided externally, and where there are no restrictions arising from environmental problems.

First Embodiment

The following is a detailed description, with references to the drawings, of a first embodiment of the present invention. :The semiconductor wafer holding mechanism of the present invention is a mechanism for holding onto and letting go of a wafer by interlocking with a semiconductor conveying operation for a semiconductor wafer using a slider between a pre-chamber and a sample stage of a sample chamber. The basic configuration is for at least three arms with pawls that slide outwards to be positioned on the sample stage. A force for supporting the wafer then acts as a result of means such as a spring etc. that normally urges the arm in a radial direction towards the inside. Then, when the wafer is transported, means are provided for broadening the arm urged towards the inside towards the outside with the slider in close proximity to the sample stage. The urging force is then resisted and the holding of the wafer is released. The conveying in and out of the wafer can then be performed using the slider with the holding in this released state.

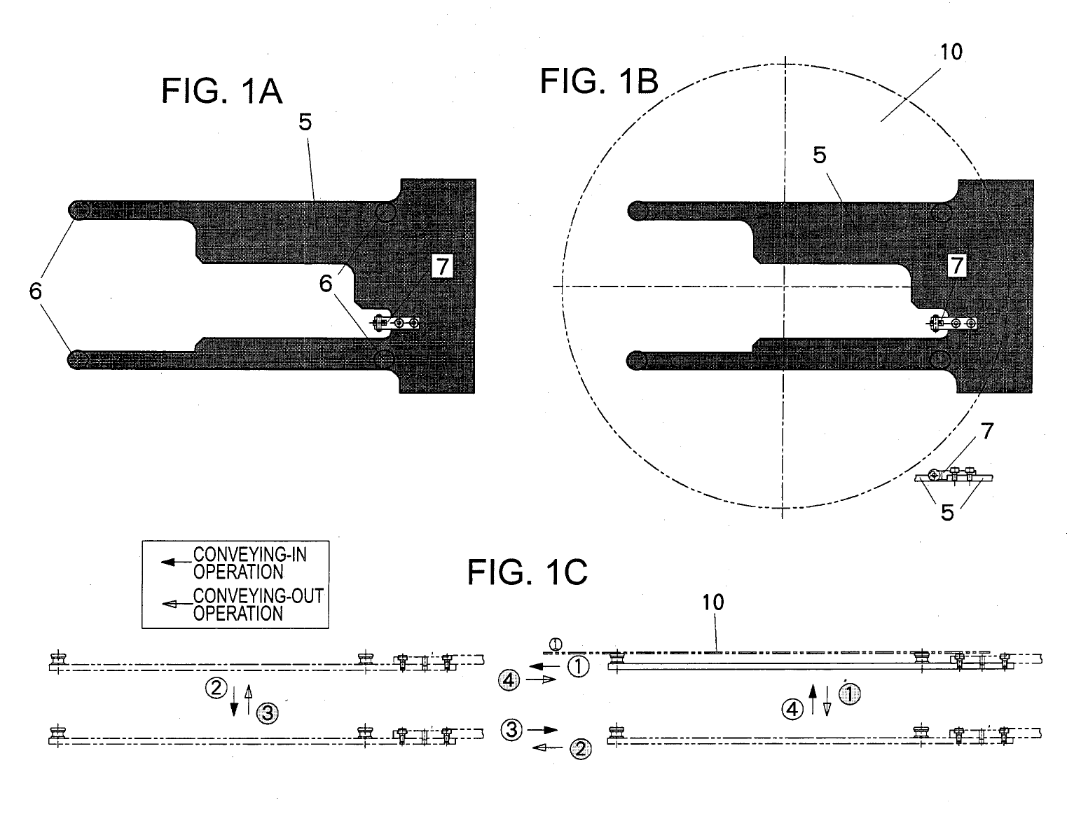

FIG. 1 is a view showing a slider member 5 constituting means for conveying a wafer between a pre-chamber and a sample stage within a sample chamber, with FIG. 1A being a plan view, FIG. 1B showing the state when a wafer 10 shown by a chain line is mounted on the slider 5, and C at the bottom being a solid view of the slider 5 showing the positional relationship in relation to the movement of the slider 5. The slider 5 is a thin plate in the shape of an inverted C. In the drawings, four pads 6 on which the wafer 10 is mounted are provided on the upper surface at an end of the inverted C-shape and a base but the number may be varied appropriately from three or more providing that the pads enable the wafer to be mounted in a stable manner. Further, a contacting member 7 is fitted in such a manner that an end projects at a reverse C-shaped notch part at the upper surface of the base of the slider 5. The height of the contacting member 7 is formed so as to be slightly lower than the height of the pads 6 so that no contact is made when mounting the wafer 10, as shown in the upper right side of FIG. 1C. In FIG. 1C, the situation shown in the upper right of the drawing shows the slider 5 at a prescribed position within the pre-chamber when not being driven.

When the wafer 10 is transported to the sample stage within the sample chamber, as shown in the drawings, the wafer 10 is mounted on the pads 6, passes through the shielding bridge wall V2 between the sample chamber 2 and the pre-chamber 3, and is conveyed upwards onto the sample stage. The position at this time is the position shown in the upper left of FIG. 1C. At this position, the slider 5 is displaced downwards (the position shown at the lower left of FIG. 1C), with the wafer 10 mounted at this time then being deposited on the sample stage. The slider 5 then passes through the shielding bridge wall V2 while remaining displaced downwards and is retracted to the pre-chamber 3 (a position shown at the bottom right of FIG. 1C) before moving upwards and returning to the original prescribed position (the position shown at the upper right of FIG. 1C). Conversely, when the wafer 10 is conveyed out from the sample stage within the sample chamber, the slider 5 is then first displaced downwards to a position shown at the bottom right of FIG. 1C from the prescribed position within the pre-chamber shown in the upper right of FIG. 1C. The slider 5 then passes through the shielding bridge wall V2 with the slider remaining displaced downwards and advances as far as the position of the sample stage (the position shown in the drawings at the lower left of FIG. 1C). At this position, the slider 5 is displaced upwards (the position shown at the upper left of FIG. 1C), the wafer 10 is removed from the sample stage 1, the slider is retracted while remaining positioned upwards, and passes through the shielding bridge wall V2 so as to return to the original prescribed position of the pre-chamber 3 (the position shown at the upper right of FIG. 1C).

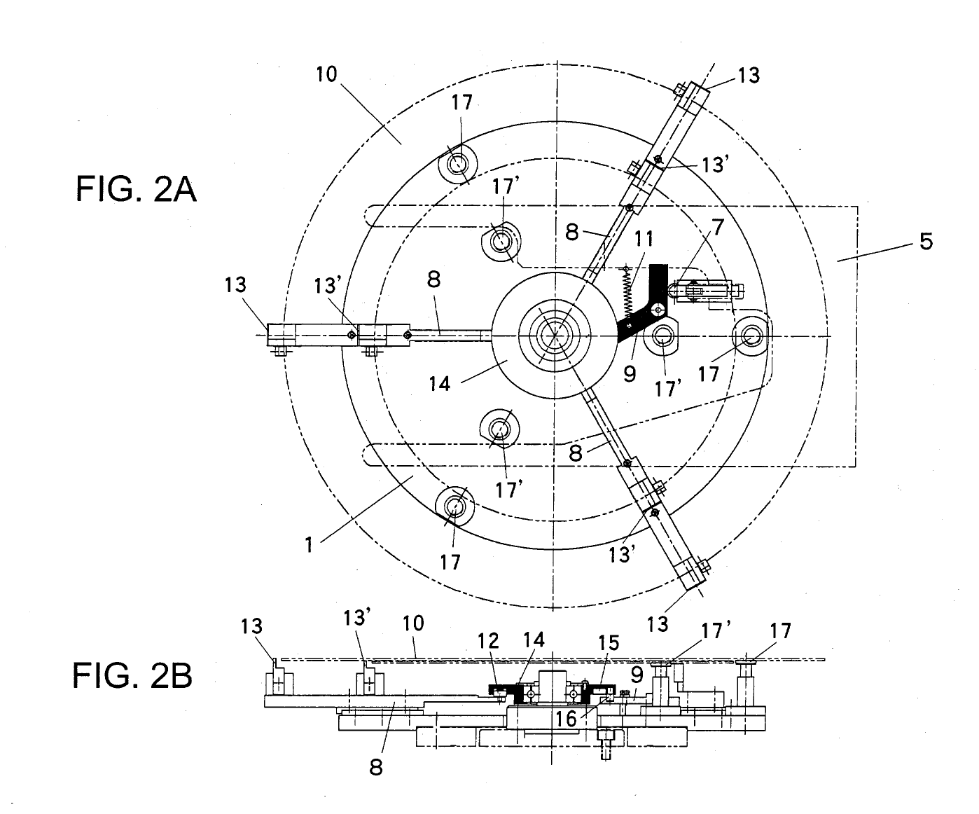

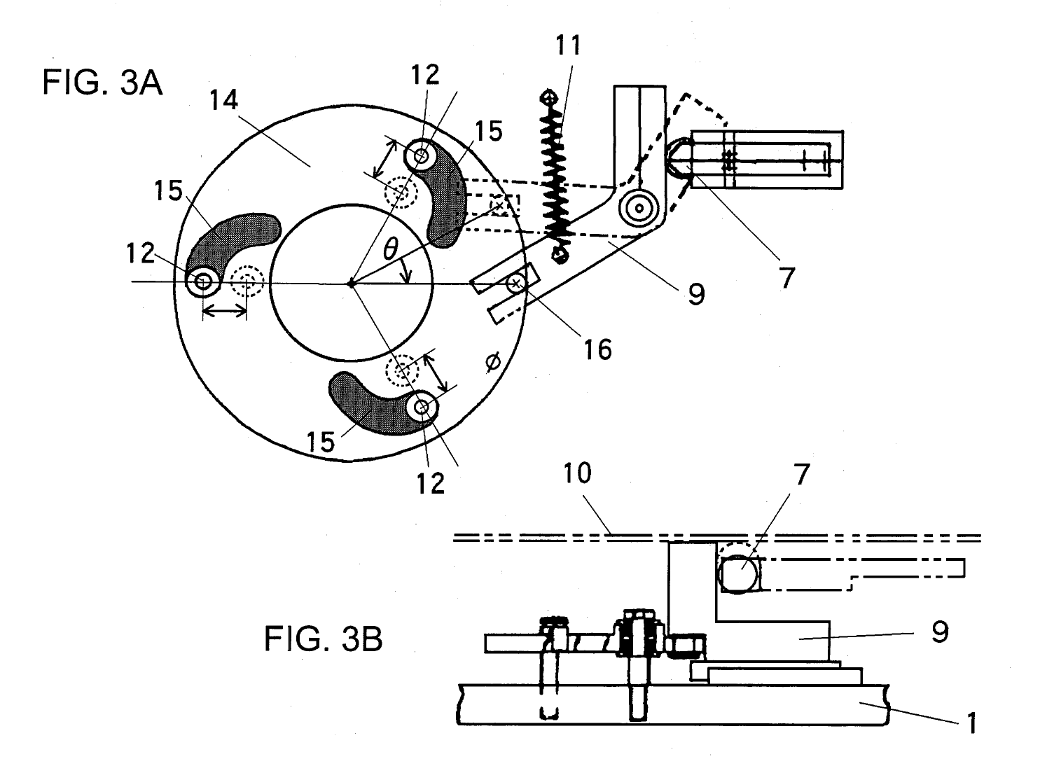

In the above operation, when the wafer 10 is deposited on the sample stage 1 and when the wafer 10 is received by the sample stage 1, it is necessary for a state on the sample stage 1 where the wafer 10 is released from the holding mechanism to be maintained, i.e. it is necessary for the pawls of the arms with pawls to be broadened towards the outside from the outer edge of the wafer 10. This operation is achieved in this embodiment by using a cam mechanism. As shown in FIG. 2, three arms with pawls 8 having pawls 13 at their tips are fitted to the sample stage 1 so as to be capable of sliding in a radial direction via a guide mechanism. A roller 12 is then installed at bases of the arms with pawls 8 as shown in FIG. 3. A small circular plate member 14 is fitted in a freely rotating manner with play remaining to a central shaft of the sample stage 1 with cam channels 15 being bored into the surface of the small circular plate member 14. When a roller 12 is then fitted into a cam channel 15, the pin member 16 is embedded at an eccentric position of the small circular plate member 14. As shown in FIG. 2 and FIG. 3, a rotating lever 9 is fitted in a moveable manner enabling pivoting about a center at the sample stage 1. A long groove 91 then fits with the pin member 16 and is urged on one direction by a spring 11. With this configuration, when the slider 5 causes the wafer 10 to be mounted on the pad 6 so as to transport the wafer from the pre-chamber, the end part of the contacting member 7 comes into contact with one side of the L-shaped rotating lever 9 and the rotating lever 9 is made to rotate while resisting the urging force of the spring 11. The small circular plate member 14 is interlocked with this rotating movement via a pin 16 of the small circular plate member 14 engaging with the long groove 91 provided at the other side of the rotating lever 9 and therefore rotates about the central shaft of the sample stage. The long channel 15,is bored into the small circular plate member 14 and a roller 12 embedded with rods with pawls 8 is fitted to the long groove 15. The roller 12 is therefore cam driven according to the rotation of the small circular plate member 14. Namely, this operation causes rotation from the position of the rotating lever 9 shown by a dashed line in FIG. 3 to a position shown by a solid line due to pressing force of the contacting member 7. In unison with this, the small circular plate member 14 rotates through an angle θ. The roller 12 for the rods with pawls 8 that are only permitted to slide in a radial direction due to the guides is then displaced from the dashed line position to that of the solid line. The displacement of the rods with pawls 8 causes the pawls 13 to be pushed so as to be broadened outwards and the wafer 10 transported by the slider 5 is deposited onto the work pads 17 provided at the sample stage 1 at the inside of the three pawls 13 in accompaniment with the downward displacement of the slider 5. The slider 5 that has deposited the wafer 10 and is now empty is then retracted as far as the pre-chamber 3 while remaining in the lower position. However, the contacting member 7 releases the pressure of the rotating lever 9 and is made to rotate in the clockwise direction in FIG. 3 by the urging force of the spring 11. This rotation displaces the rods with pawls 8 towards the inside via the small circular plate member 14 and the pawls 13 are displaced until contact is made with the outer edge of the wafer 10 deposited on the work pad 17. At this time, the wafer 10 is sandwiched by the pawls 13 of the three rods with pawls 8 on the sample stage 1. At the sandwiching force, the urging force of the spring 11 acts via the cam mechanism of the small circular plate member 14 and the rotating lever 9. This sandwiching force usually acts from the time when the wafer 10 is introduced to the sample stage 1 until the wafer 10 is carried out again so as to reliably and stably hold the wafer 10 constituting the sample during observation and processing.

When the wafer 10 is being carried out, the empty slider 5 is advanced from the pre-chamber 3 at a low position. The contacting member 7 then makes contact with one side of the rotating lever 9 and the rotating lever 9 rotates while resisting the urging force of the spring 11. One side of the rotating lever 9 is provided at such a height that the contacting relationship can be achieved whether the slider 5 is in a high position or low position. Rotation of the rotating lever 9 then causes the rods with pawls 8 to be displaced outwards via the cam mechanism of the small circular plate member 14 and the sandwiching of the wafer 10 with the pawls 13 is then released. In this state, the slider 5 is displaced upwards and the wafer 10 mounted on the work pads 17 are then deposited onto its own pads 6. The slider 5 is then retracted as far as the pre-chamber 3 and is carried out. As described above, in the present invention, an urging force due to a spring etc. usually acts without having to use a special drive source for supporting the wafer constituting the sample. This force is then released only when carrying the sample in and out. This releasing then utilizes the drive source for the sample conveying operation carried out between the sample chamber 2 and the pre-chamber 3. Further, various types of differing dimensions such as, for example, 300 mm and 200 mm exist as wafers 10 constituting the sample and this embodiment is also capable of holding wafers of different diameters. As can be understood from the solid drawing in FIG. 2, small diameter work pads 17′ provided in addition to the large diameter work pads 17 at the sample stage 1 and small diameter pawls 13′ provided in addition to the large diameter pawls 13 at the rods with pawls 8 may also be provided. All of the small diameter cases are provided at slightly lower positions so that a small diameter wafer fits into the inside of the large diameter work pad 17 and are configured in such a way that the small diameter pawls 13′ do not damage the wafer when a large diameter wafer is on the large diameter work pad 17.

Second Embodiment

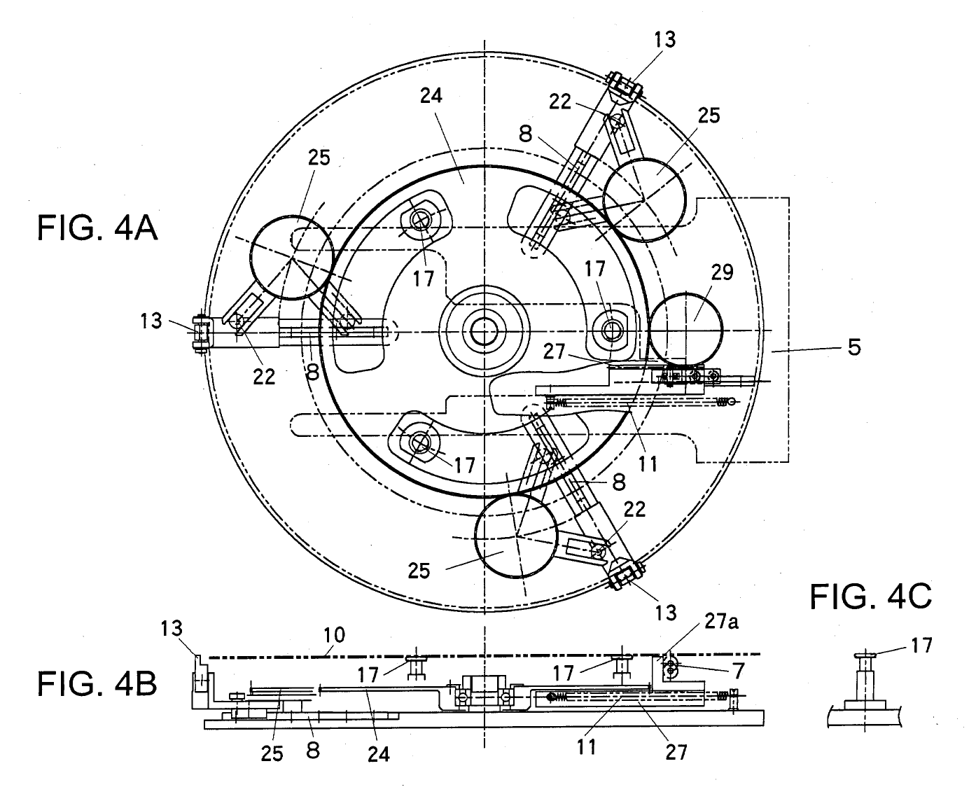

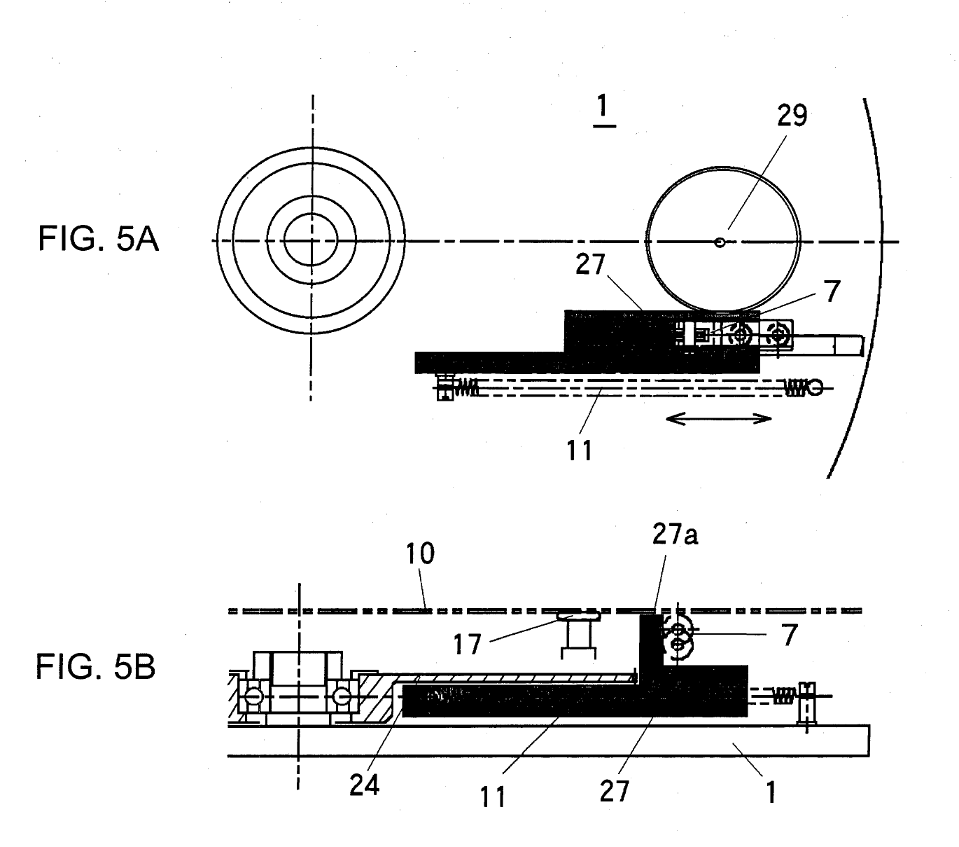

Next, a further embodiment of the present invention will be described with reference to FIG. 4 and FIG. 5. Whereas the previous embodiment displaced rods with pawls in a radial direction by utilizing a cam mechanism, this embodiment utilizes a gear mechanism to displace rods with pawls in a radial direction. The sample stage 1 of this embodiment is provided with a rack member 27 capable of being made to slide by a guide in line with the sliding direction of the slider 5 as shown in an enlarged manner in FIG. 5. The rack member is then urged in a radial direction of the sample stage towards the outside by a spring 11. In the process where the slider 5 advances in the direction of the sample stage 1, the contacting member 7 makes contact with a contacting part 27a of the rack member and when the whole of the rack member 27 slides towards the inside while resisting the spring. The rack member 27 meshes with a gear 29 fitted at the sample stage 1 and applies rotating force to the gear 29. Describing the gear mechanism of this embodiment while referring to FIG. 4, the gear 29 meshes with a large gear 24 fitted with play to the central shaft of the sample stage 1. This large gear 24 then has gear trains meshing with three gears with levers 25. As can be discerned from FIG. 5B (solid drawing), the rack member 27 is arranged so as to slide in the space between the sample stage 1 and the large gear 24. As shown in FIG. 4, the gear 29 and the gears with levers 25 are fitted in a freely rotatable manner to shafts on the sample stage 1 and the ends of the levers of the gears with levers 25 are cut with long grooves, with the long grooves then fitting with pins 22 of the rods with pawls 8. With this configuration, when the slider causes the wafer 10 to be mounted on the pad 6 so as to transport the wafer from the pre-chamber, the end part of the contacting member 7 attached to the slider 5 comes into contact with the contacting part 27a of the rack member and the whole of the rack member 27 is caused to slide to the inside against the force of the spring. The movement of the rack member 27 causes the gear 29 to rotate in a clockwise direction in the drawings while engaging with the gear 29 at the side of the sample stage 1. The gear 29 interlocks the large gear 24 constituting the gear train and the gears with levers 25 and the rack member 27 is urged by the spring 11. The rotation in the anti-clockwise direction of the large gear 24 and the rotation in the clockwise direction of the gear 29 and the gears with levers 25 is therefore rotation that is against this urging force. As a result of this rotation, the three gears with levers 25 rotate in a clockwise direction so that the pins 22 are displaced to the outside. These pins 22 are embedded in the rods with pawls 8 that can slide freely in the radial direction so that the whole of the rods with pawls 8 are displaced towards the outside in the radial direction. In this situation, when the slider 5 is displaced downwards, the wafer 10 mounted on the pads 6 is housed inside of the three pawls 13 and is deposited at the work pads 17 on the sample stage 1. When the empty slider 5 reaches the lowermost position, next, the slider begins to retract to the pre-chamber 3 while maintaining this lowermost position. In the retracting step, the rack member 27 rotates in an anti-clockwise direction, and the gears with levers 25 is also rotated in an anti-clockwise direction by the interlocking of the gear train and the rods with pawls 8 are displaced towards the inside. As a result of this motion, the pawl 13 makes contact with the outer edge of the wafer 10 so that the wafer is sandwiched at three points. When this state is reached, the rods with pawls 8 are already no longer displaced towards the inside. The movement of the gears with levers 25, large gear 24, and gear train of the gear 29 and the rack member 27 is stopped. The urging force of the spring 11 applied to the rack member 27 is transmitted to the pawls 13 via a continuous gear train and the wafer 10 is sandwiched. As with the previous embodiment, this sandwiching force usually acts from the time when the wafer 10 is introduced to the sample stage 1 until the wafer 10 is carried out again so as to reliably and stably hold the wafer 10 constituting the sample during observation and processing.

When the wafer 10 is being carried out, the empty slider 5 is advanced from the pre-chamber 3 at a low position. The contacting member 7 then makes contact with the contacting part 27a of the rack member and the rack member 27 rotates while resisting the urging force of the spring 11. The contacting part 27a of the rack member is provided at such a height that the contacting relationship can be achieved whether the slider 5 is in a high position or low position, as can be discerned from the solid drawing in FIG. 5. The displacement of the rack member 27 then causes the rods with pawls 8 to be displaced outwards via the gear 29, large gear 24 and gears with levers 25 and the sandwiching of the wafer 10 with the pawls 13 is then released. In this state, the slider 5 is displaced upwards and the wafer 10 mounted on the work pads 17 are then deposited onto its own pads 6. The slider 5 is then retracted as far as the pre-chamber 3 and is carried out. Further, various types of wafers 10 of differing dimensions such as, for example, diameters of 300 mm and 200 mm exist as wafers 10 constituting the sample. However, this embodiment utilizes a gear train. It is also possible to convert the displacement of the rack member 27 to the large strokes of the rods with pawls 8 by combining appropriate gears. Compatibility with large and small diameter wafers is therefore possible with only one pawl 13 and it is not necessary to provide individual pawls 13, 13′ as in the previous embodiment.

The semiconductor wafer support mechanism for a sample stage of the present invention has at least three arms with pawls capable of sliding in a radial direction so as to hold and release a wafer arranged on a sample stage, normally holds a wafer using means for urging the arms towards the inside in a radial direction, and has means for broadening the arms urged towards the inside towards the outside when the slider is in a state of close proximity with the sample stage in unison with an operation of conveying the semiconductor wafer performed by a slider between a pre-chamber and a sample stage of a sample chamber in order to release the holding due to urging force when transporting the wafer. It is therefore not necessary to provide a special holding drive means and problems aligning with external mechanisms causing inconvenience in designing narrow sample chambers no longer occur. Further, there is no hindrance provided by a vacuum environment or magnetic environment. By adopting a configuration where the urging means and means for broadening the urged arms to the outside comprise contacting member fitted to the sliders; a rotating lever provided at the sample stage which makes contact with the contacting member; a spring urging the rotating lever in one direction; and a cam mechanism for causing rotation of the rotating lever to cause the arms with pawls to slide in a radial direction, it is possible to achieve the desired object with a simple configuration and a reliable and stable operation can be maintained without hindrance.

By adopting a configuration where the urging means and the means for broadening the urged arms to the outside comprises a contacting member fitted to the slider, a rack member provided at the sample stage and making contact with the contacting member, gears provided at the sample stage meshing with the rack member, a gear train for transmitting rotation of the gears, a mechanism for causing the arms with pawls to slide in the radial direction using the rotation force of the gear train, and a spring fitted to the rack member in such a manner that the arms fitted with pawls are urged inwards in the radial direction, it is possible to achieve the desired object with a simple configuration and a reliable and stable operation can be maintained without hindrance. Moreover, by utilizing a gear train, the stroke of the rods with pawls can be made large and wafers of both large and small dimensions can be reliably held with a single pawl.

What is claimed is:

1. A semiconductor wafer support mechanism with at least three arms with pawls capable of sliding in a radial direction so as to hold and release a wafer arranged on a sample stage, comprising:
means for urging the arms for holding the wafer inwards in a radial direction; and
means for broadening the arms urged towards the inside towards the outside when the slider is in a state of close proximity with the sample stage in unison with an operation of conveying; the semiconductor wafer between a pre-chamber and a sample stage of a sample chamber performed by a slider.

2. The semiconductor wafer holding mechanism according to claim 1, wherein the urging means and means for broadening the urged arms to the outside comprise a contacting member fitted to the slider, a rotating lever provided at the sample stage so as to make contact with the contacting member, a spring urging the rotating lever in one direction; and a cam mechanism for causing rotation of the rotating lever to cause the arms with pawls to slide in a radial direction.

3. The semiconductor wafer support mechanism according to claim 2, wherein the cam mechanism for sliding the arm with pawls in the radial direction comprises cam channels embedded in the surface of a small circular plate member fitted in a freely rotatable manner with play at a central shaft of the sample stage so that rollers of the arms with pawls fit into the cam channels and a pin member fitting with a long groove of a rotating lever is provided so as to be embedded at an eccentric position in the small circular plate member.

4. The semiconductor wafer support mechanism according to claim 1, wherein the urging means and the means for broadening the urged arms to the outside comprises a contacting member fitted to the slider, a rack member provided at the sample stage and making contact with the contacting member, a gear provided at the sample stage meshing with the rack member, a gear train for transmitting rotation of the gear, a mechanism for causing the arms with pawls to slide in the radial direction using the rotation force of the gear train, and a spring fitted to the rack member in such a manner that the arms fitted with pawls are urged inwards in the radial direction.

5. The semiconductor wafer holding mechanism according to claim 4, wherein the mechanism for causing the arms with pawls to slide in the radial direction due to the rotational force of the gear train comprises gears with levers having long grooves and pins on the arms with pawls fitting with the long grooves, and the rack member is guided in the direction of movement of the slider at the sample stage in a freely slidable manner.
